(19) United States
(12) Patent Application Publication
(10) Pub. No.: US 2025/0346975 A1
(43) Pub. Date: Nov. 13, 2025

(54) WELDED JOINT

(71) Applicant: NIPPON STEEL CORPORATION, Tokyo (JP)

(72) Inventors: Takuya MITSUNOBU, Tokyo (JP); Mamoru SAITO, Tokyo (JP); Hiroshi TAKEBAYASHI, Tokyo (JP)

(73) Assignee: NIPPON STEEL CORPORATION, Tokyo (JP)

(21) Appl. No.: 18/660,836

(22) Filed: May 10, 2024

(51) Int. Cl. C22C 30/00; B23K 9/00; B23K 26/00; B23K 26/322; B23K 35/22; B23K 35/30; B23K 103/04; C23C 2/02; C23C 2/06; C23C 2/28; C23C 2/40

(52) U.S. Cl. CPC C22C 30/00; B23K 9/0026; B23K 26/0006; B23K 26/322; B23K 35/226; B23K 35/3093; C23C 2/022; C23C 2/06; C23C 2/29; C23C 2/40; B23K 2103/04

(57) ABSTRACT

A welded joint 10 is a welded joint 10 in which a first steel sheet 1 and a second steel sheet 2 having a plating layer 4 at least on a part thereof are welded, Expression (1) is satisfied, where La is a length of a grain boundary at which an Fe—Al phase is present in grain boundaries and Lz is a length of a grain boundary at which an Fe—Zn phase is present in the grain boundaries, and an area ratio of an Mg—Zn phase in the plating layer 4 of a region from a starting point S to a position 1,000 μm away from the starting point S is 5% or more.

$$La / ( La + Lz ) \times 100 \geq 20 \qquad ( 1 )$$

### BACKGROUND OF THE INVENTION

### Field of the Invention

The present disclosure relates to a welded joint.

### Description of the Background

Zn—Al—Mg-based hot-dip plated steel sheets having a hot-dip Zn plating layer containing μl and Mg have excellent red rust resistance. Therefore, Zn—Al—Mg-based hot-dip plated steel sheets are widely used as materials for structural members such as building materials that require corrosion resistance.

In the production of structural members, fusion welding such as arc welding may be performed in joining materials together. In fusion welding of a Zn—Al—Mg-based hot-dip plated steel sheet, a region where a plating layer remains and a region where no plating layer remains are formed in a heat-affected zone. In the region where the plating layer remains in the heat-affected zone, the plating layer has a different composition from that of the plating layer of a non-heat-affected zone, and thus expected red rust resistance may not be obtained.

In addition, since the plating layer melts in the heat-affected zone, Zn in the plating may infiltrate into grain boundaries of the surface layer region of a base steel sheet and cause liquid metal embrittlement (LME), resulting in the occurrence of cracks (LME cracking). Therefore, the Zn—Al—Mg-based hot-dip plated steel sheet to be fusion-welded is required to have a property of being less likely to cause LME, that is, excellent LME resistance.

For example, Patent Document 1 discloses a vehicle chassis member having a joining portion obtained by joining together hot-dip Zn—Al—Mg-based alloy-plated steel sheet members having a sheet thickness of 1.0 to 3.0 mm by arc welding, in which a steel sheet surface having a plating layer before welding is continuously covered with a Zn—Al—Mg-based alloy layer up to a weld bead toe portion, an Fe—Al-based alloy layer is present between the Zn—Al—Mg-based alloy layer and a steel base, and in a steel sheet surface layer portion within 2 mm away from the weld bead toe portion, the Zn—Al—Mg-based alloy layer has an average Al concentration of 0.2 to 22.0 mass % and an average Mg concentration of 1.0 to 10.0 mass %, and the Fe—Al-based alloy layer has an average Fe concentration of 70.0 mass % or less. Patent Document 1 discloses that, with the above-described configuration, a decrease in corrosion resistance is avoided in a portion near the bead toe portion of the arc welding portion, and thus a vehicle chassis having high strength and high corrosion resistance can be constructed.

### BACKGROUND ART DOCUMENT

### Patent Document

Patent Document 1: Japanese Patent No. 5700394

### SUMMARY OF THE INVENTION

### Problems to be Solved by the Invention

However, Patent Document 1 does not consider LME resistance and red rust resistance in the heat-affected zone.

The present disclosure has been made in view of the above circumstances. An object of the present disclosure is to provide a welded joint having excellent LME resistance and red rust resistance in a heat-affected zone.

### Means for Solving the Problem

The gist of the present disclosure is as follows.

[1] A welded joint in which a first steel sheet and a second steel sheet are welded, the welded joint including:
the first steel sheet and the second steel sheet; and
a weld bead portion formed by welding,
in which each of the first steel sheet and the second steel sheet has a heat-affected zone positioned around the weld bead portion, and a non-heat-affected zone not affected by heat due to the welding,
the first steel sheet has a plating layer on a surface in the heat-affected zone and the non-heat-affected zone,
the plating layer of the non-heat-affected zone includes, as a chemical composition, by mass %,
Al: 5.0% to 40.0%,
Mg: 3.0% to 15.0%,
Fe: 0.01% to 15.00%,
Si: 0% to 10.00%,
Ca: 0% to 1.5000%,
Sb: 0% to 0.5000%,
Pb: 0% to 0.5000%,
Sr: 0% to 0.5000%,
Cu: 0% to 1.0000%,
Ti: 0% to 1.0000%,
V: 0% to 1.0000%,
Cr: 0% to 1.0000%,
Nb: 0% to 1.0000%,
Ni: 0% to 1.0000%,
Mn: 0% to 1.0000%,
Mo: 0% to 1.0000%,
Sn: 0% to 1.0000%,
Zr: 0% to 1.0000%,
Co: 0% to 1.0000%,
W: 0% to 1.0000%,
Ag: 0% to 1.0000%,
Li: 0% to 1.0000%,
La: 0% to 0.5000%,
Ce: 0% to 0.5000%,
Y: 0% to 0.5000%,
Bi: 0% to 0.5000%,
In: 0% to 0.5000%,
B: 0% to 0.5000%, and
a remainder comprising Zn of 20.000% or more and impurities,
when observing a cross section orthogonal to an extending direction of the weld bead portion, in a surface having the weld bead portion,
toward a direction orthogonal to the extending direction of the weld bead portion and away from a toe of the weld bead portion, in a region from a position set as a starting point where coating with the plating layer is started to a position 1,000 μm away from the starting point, and in a surface layer region that is a region from the surface of the first steel sheet to a position 50 μm away from the surface,
Expression (1) is satisfied, where La is a length of a grain boundary at which an Fe—Al phase is present in grain boundaries and Lz is a length of a grain boundary at which an Fe—Zn phase is present in the grain boundaries, and
an area ratio of an Mg—Zn phase in the plating layer of the region from the starting point to the position 1,000 μm away from the starting point is 5% or more.

La/(La+Lz)×100≥20 (1)

[2] The welded joint according to [1], in which the plating layer of the non-heat-affected zone includes, as the chemical composition, by mass %, one or more of
Si: 0.01% to 10.00%,
Ca: 0.0001% to 1.5000%,
Sb: 0.0001% to 0.5000%,
Pb: 0.0001% to 0.5000%,
Sr: 0.0001% to 0.5000%,
Cu: 0.0001% to 1.0000%,
Ti: 0.0001% to 1.0000%,
V: 0.0001% to 1.0000%,
Cr: 0.0001% to 1.0000%,
Nb: 0.0001% to 1.0000%,
Ni: 0.0001% to 1.0000%,
Mn: 0.0001% to 1.0000%,
Mo: 0.0001% to 1.0000%,
Sn: 0.0001% to 1.0000%,
Zr: 0.0001% to 1.0000%,
Co: 0.0001% to 1.0000%,
W: 0.0001% to 1.0000%,
Ag: 0.0001% to 1.0000%,
Li: 0.0001% to 1.0000%,
La: 0.0001% to 0.5000%,
Ce: 0.0001% to 0.5000%,
Y: 0.0001% to 0.5000%,
Bi: 0.0001% to 0.5000%,
In: 0.0001% to 0.5000%, and
B: 0.0001% to 0.5000%.

[3] The welded joint according to [1] or [2], in which the plating layer of the non-heat-affected zone includes, as the chemical composition, by mass %,
Mg: 4.5% to 15.0%, and
the area ratio of the Mg—Zn phase in the plating layer of the region is 20% or more.

[4] The welded joint according to [1] or [2], in which the plating layer of the non-heat-affected zone includes, as the chemical composition, by mass %,
Mg: 5.5% to 15.0%, and
the area ratio of the Mg—Zn phase in the plating layer of the region is 30% or more.

[5] The welded joint according to any one of [1] to [4], in which the plating layer of the non-heat-affected zone includes, as the chemical composition, by mass %,
Al: 10.0% to 40.0%, and
a value on a left side of Expression (1) is 50 or more.

[6] The welded joint according to any one of [1] to [4], in which the plating layer of the non-heat-affected zone includes, as the chemical composition, by mass %,
Al: 15.0% to 40.0%, and
a value on a left side of Expression (1) is 80 or more.

[7] The welded joint according to any one of [1] to [6], in which the plating layer of the non-heat-affected zone includes, as the chemical composition, by mass %,
Sn: 0.0200% to 1.0000%, and
the plating layer of the non-heat-affected zone has an Mg₂Sn phase.

### Effects of the Invention

According to the aspect of the present disclosure, it is possible to provide a welded joint having excellent LME resistance and red rust resistance in a heat-affected zone.

### BRIEF DESCRIPTION OF THE DRAWINGS

FIG. 1 is a diagram showing a cross section near a weld bead portion of a welded joint.

FIG. 2 is an enlarged view of a heat-affected zone of a bead surface of the welded joint.

FIG. 3 is an enlarged view of a part of a region from a starting point S to a position 1,000 μm away from the starting point S.

FIG. 4 is a diagram showing a cross section near a weld bead portion of a lap joint.

FIG. 5 is a diagram showing a cross section near a weld bead portion of a T-joint.

### DETAILED DESCRIPTION OF THE INVENTION

A welded joint according to an embodiment of the present disclosure (hereinafter, may be referred to as the welded joint according to the present embodiment) will be described. However, the present disclosure is not limited to the configuration disclosed in the present embodiment, and various modifications can be made without departing from the gist of the present disclosure.

Hereinafter, individual configuration requirements of the present disclosure will be described in detail.

The numerical limit range described below with “to” in between includes the lower limit and the upper limit. Numerical values indicated as “less than” or “more than” do not fall within the numerical range. In the following description, % regarding the chemical composition is mass % unless otherwise specified.

In addition, terms related to welding conform to JIS Z 3001:2018-1 to 7.

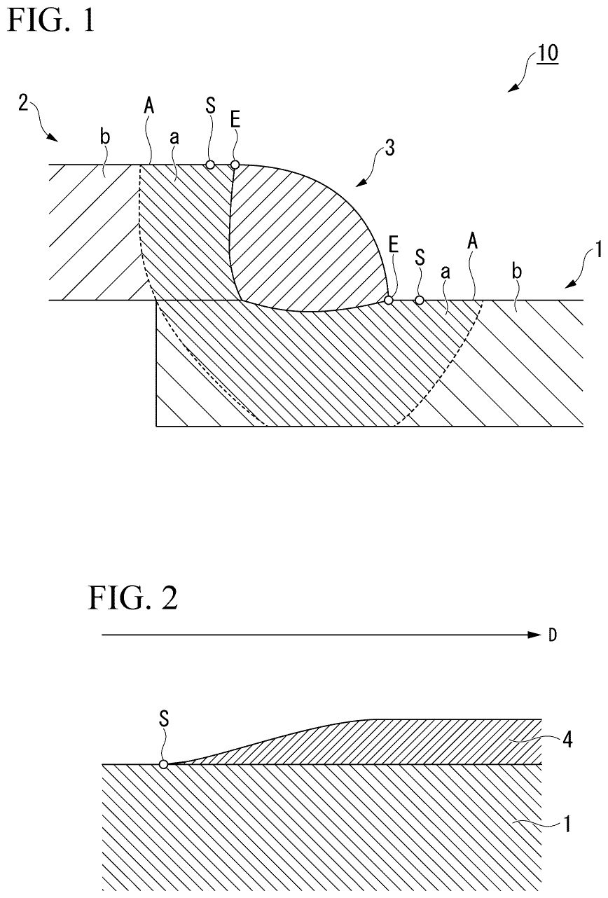

A welded joint according to the present embodiment is a welded joint 10 in which a first steel sheet 1 and a second steel sheet 2 are welded as shown in FIG. 1, including: the first steel sheet 1 and the second steel sheet 2; and a weld bead portion 3 formed by welding, in which each of the first steel sheet 1 and the second steel sheet 2 has a heat-affected zone a positioned around the weld bead portion 3 and a non-heat-affected zone b not affected by heat due to the welding, and the first steel sheet 1 or the second steel sheet 2 or combination thereof has a plating layer 4 (not shown in FIG. 1) positioned on at least a part of a surface in the heat-affected zone a and the non-heat-affected zone b.

Hereinafter, each configuration will be described in detail.

The materials of the first steel sheet 1 and the second steel sheet 2 are not particularly limited. For example, various kinds of steel sheets such as general steels, Al-killed steels, ultra-low-carbon steels, high carbon steels, various high tensile strength steels, and some high alloy steels (steels containing strengthening elements such as Ni and Cr).

The method of producing the first steel sheet 1 and the second steel sheet 2 (hot rolling method, pickling method, cold rolling method, and the like) is not particularly limited.

The weld bead portion 3 is formed of a weld bead formed by welding. The shape and composition of the weld bead portion 3 are not particularly limited.

The heat-affected zone a affected by heat due to welding and the non-heat-affected zone b not affected by heat due to welding are present around the weld bead portion 3. Zn in the plating layer 4 may be evaporated by heat during welding. Therefore, the composition of the plating layer 4 of the heat-affected zone a may be different from that of the plating layer 4 of the non-heat-affected zone b. In addition, the heat-affected zone a has a part where no plating layer 4 is present, since the plating layer 4 melts and infiltrates into a surface layer region of the first steel sheet 1, or melts away.

First, the chemical composition of the plating layer 4 of the non-heat-affected zone b will be described. In the welded joint 10 according to the present embodiment, in a case where the chemical composition of the plating layer 4 of the non-heat-affected zone b is within ranges described below, the chemical composition of the plating layer 4 remaining in the heat-affected zone a can also be preferably controlled, and thus the LME resistance and the red rust resistance in the heat-affected zone can be improved.

The chemical composition of the plating layer 4 of the non-heat-affected zone b includes, by mass %, Al: 5.0% to 40.0%, Mg: 3.0% to 15.0%, Fe: 0.01% to 15.00%, and a remainder comprising Zn of 20.000% or more and impurities.

Each element will be described below.

### Al: 5.0% to 40.0%

Al is an element that infiltrates into grain boundaries of the surface layer region of the first steel sheet 1 in the heat-affected zone and forms an Fe—Al phase, thereby increasing LME resistance. In a case where the Al content is less than 5.0%, the Fe—Al phase is not formed in a sufficient amount at the grain boundaries, and thus the LME resistance deteriorates. Therefore, the Al content is set to 5.0% or more. The Al content is preferably 10.0% or more, and more preferably 15.0% or more from the viewpoint of forming a larger amount of the Fe—Al phase at the grain boundaries and further increasing the LME resistance.

On the other hand, in a case where the Al content is more than 40.0%, the LME resistance deteriorates instead. Therefore, the Al content is set to 40.0% or less. The Al content is preferably 35.0% or less or 30.0% or less, and more preferably 25.0% or less.

### Mg: 3.0% to 15.0%

Mg is a necessary element for forming an Mg—Zn phase. In a case where the Mg content is less than 3.0%, the Mg—Zn phase cannot be formed in a sufficient amount in the heat-affected zone, and thus the red rust resistance deteriorates. In addition, in a case where the Mg content is less than 3.0%, only Zn infiltrates into the grain boundaries of the surface layer region of the first steel sheet 1 in the heat-affected zone, and thus the Fe—Al phase cannot be sufficiently formed at the grain boundaries. Therefore, the LME resistance deteriorates. Therefore, the Mg content is set to 3.0% or more. Although the detailed mechanism is unknown, the present inventors presume that in a case where a sufficient amount of Mg is contained, the Al potential changes at the grain boundaries, and as a result, the Fe—Al phase can be sufficiently formed at the grain boundaries. The Mg content is preferably 4.0% or more or 4.5% or more, and more preferably 5.0% or more or 5.5% or more.

On the other hand, in a case where the Mg content is more than 15.0%, a large amount of dross mainly containing Mg is generated in a plating bath, and the dross is likely to adhere to the plating original sheet. Therefore, the plating layer 4 cannot be formed in some cases. Therefore, the Mg content is set to 15.0% or less. The Mg content is preferably 12.0% or less or 10.0% or less, and more preferably 7.0% or less.

### Fe: 0.01% to 15.00%

Since Fe may be mixed in the plating layer 4 from the first steel sheet 1 during the formation of the plating layer 4, it is difficult to reduce the Fe content in the plating layer 4 to 0%. Therefore, the Fe content is set to 0.01% or more. The Fe content may be 0.05% or more or 0.10% or more.

In addition, in a case where the Fe content is 15.00% or less, the properties of the plating layer 4 are not adversely affected. Therefore, the Fe content is set to 15.00% or less. The Fe content may be 10.00% or less, 5.00% or less, or 3.00% or less.

The plating layer 4 of the non-heat-affected zone b may have the above-described chemical composition and a remainder comprising Zn of 20.000% or more and impurities. In a case where the Zn content is less than 20.000%, desired red rust resistance and LME resistance cannot be obtained. The Zn content is preferably 40.000% or more or 50.000% or more, and more preferably 55.000% or more, 60.000% or more, 65.000% or more, or 70.000% or more.

In the present embodiment, impurities mean those mixed from the production environment or the like and/or those allowed within a range that does not adversely affect the properties of the welded joint 10 according to the present embodiment.

Although not essential for providing desired properties, the following optional elements may be contained in the plating layer 4 according to the present embodiment. However, since it is not essential that these elements be contained, the lower limits of the amounts of these elements are 0%.

### Si: 0.01% to 10.00%

Si contributes to an improvement in the red rust resistance. In order to reliably obtain this effect, the Si content is preferably set to 0.01% or more. The Si content is more preferably 0.05% or more or 0.10% or more.

On the other hand, in a case where the Si content is more than 10.00%, the red rust resistance deteriorates instead. Therefore, the Si content is set to 10.00% or less. The Si content is more preferably 5.00% or less, 3.00% or less, or 1.00% or less.

### Ca: 0.0001% to 1.5000%

Ca is an element that can adjust the optimum amount of Mg eluted for imparting red rust resistance. In order to reliably obtain this effect, the Ca content is preferably set to 0.0001% or more. The Ca content is more preferably 0.1000% or more or 0.3000% or more.

On the other hand, in a case where the Ca content is excessive, the red rust resistance and workability deteriorate. Therefore, the Ca content is set to 1.5000% or less. The Ca content is more preferably 1.0000% or less or 0.8000% or less.
Sb: 0.0001% to 0.5000%
Pb: 0.0001% to 0.5000%
Sr: 0.0001% to 0.5000%

Sb, Pb, and Sr contribute to an improvement in the red rust resistance. In order to reliably obtain this effect, the amount of any one of Sb, Pb, and Sr is preferably set to 0.0001% or more. Each of the Sb content, the Pb content, and the Sr content is more preferably 0.0005% or more or 0.0050% or more.

On the other hand, in a case where the amount of any one of Sb, Pb, and Sr is more than 0.5000%, the red rust resistance deteriorates instead. Therefore, each of the Sb content, the Pb content, and the Sr content is set to 0.5000% or less. Each of the Sb content, the Pb content, and the Sr content is more preferably 0.3000% or less or 0.2000% or less.
Cu: 0.0001% to 1.0000%
Ti: 0.0001% to 1.0000%
V: 0.0001% to 1.0000%
Cr: 0.0001% to 1.0000%
Nb: 0.0001% to 1.0000%
Ni: 0.0001% to 1.0000%
Mn: 0.0001% to 1.0000%
Mo: 0.0001% to 1.0000%

Cu, Ti, V, Cr, Nb, Ni, Mn, and Mo contribute to an improvement in the red rust resistance. In order to reliably obtain this effect, the amount of any one of the above elements is preferably set to 0.0001% or more. Each of the amounts of the above elements is more preferably 0.0005% or more or 0.0050% or more.

On the other hand, in a case where the amount of any one of the above elements is more than 1.0000%, the red rust resistance deteriorates instead. Therefore, each of the amounts of the above elements is set to 1.0000% or less. Each of the amounts of the above elements is more preferably 0.3000% or less or 0.2000% or less.

### Sn: 0.0001% to 1.0000%

Sn is an element that forms an Mg₂Sn phase with Mg and improves red rust resistance. In order to reliably obtain this effect, the Sn content is preferably set to 0.0001% or more. In order to form an Mg₂Sn phase in the plating layer 4 of the heat-affected zone a and further improve the red rust resistance of the bead surface in the heat-affected zone, the Sn content is more preferably set to 0.0200% or more.

On the other hand, in a case where the Sn content is more than 1.0000%, the red rust resistance deteriorates instead. Therefore, the Sn content is set to 1.0000% or less. The Sn content is preferably 0.5000% or less or 0.3000% or less.
Zr: 0.0001% to 1.0000%
Co: 0.0001% to 1.0000%
W: 0.0001% to 1.0000%
Ag: 0.0001% to 1.0000%
Li: 0.0001% to 1.0000%

Zr, Co, W, Ag, and Li are elements that improve red rust resistance. In order to reliably obtain this effect, the amount of any one of Zr, Co, W, Ag, and Li is preferably set to 0.0001% or more. Each of the Zr content, the Co content, the W content, the Ag content, and the Li content is more preferably 0.0005% or more or 0.0020% or more.

On the other hand, in a case where the Zr content, the Co content, the W content, the Ag content, and the Li content are excessive, the red rust resistance deteriorates. In a case where the amount of any one of Zr, Co, W, Ag, and Li is more than 1.0000%, the red rust resistance significantly deteriorates. Therefore, each of the Zr content, the Co content, the W content, the Ag content, and the Li content is set to 1.0000% or less. Each of the Zr content, the Co content, the W content, the Ag content, and the Li content is preferably 0.5000% or less or 0.1000% or less.
La: 0.0001% to 0.5000%
Ce: 0.0001% to 0.5000%
Y: 0.0001% to 0.5000%

La, Ce, and Y contribute to an improvement in the red rust resistance. In order to reliably obtain this effect, the amount of any one of La, Ce, and Y is preferably set to 0.0001% or more. Each of the La content, the Ce content, and the Y content is more preferably 0.0005% or more or 0.0050% or more.

On the other hand, in a case where the amount of any one of La, Ce, and Y is more than 0.5000%, the red rust resistance deteriorates instead. Therefore, each of the La content, the Ce content, and the Y content is set to 0.5000% or less. Each of the La content, the Ce content, and the Y content is more preferably 0.2000% or less or 0.1000% or less.
Bi: 0.0001% to 0.5000%
In: 0.0001% to 0.5000%
B: 0.0001% to 0.5000%

Bi, In, and B contribute to an improvement in the red rust resistance. In order to reliably obtain this effect, the amount of any one of Bi, In, and B is preferably set to 0.0001% or more. Each of the Bi content, the In content, and the B content is more preferably 0.0005% or more or 0.0050% or more.

On the other hand, in a case where the amount of any one of Bi, In, and B is more than 0.5000%, the red rust resistance deteriorates instead. Therefore, each of the Bi content, the In content, and the B content is set to 0.5000% or less. Each of the Bi content, the In content, and the B content is more preferably 0.2000% or less or 0.1000% or less.

The chemical composition of the plating layer 4 is measured by the following method.

A test piece having a size of 20 mm×20 mm×sheet thickness is collected from the non-heat-affected zone b (a position 100 mm or more away from the weld bead portion 3) of the first steel sheet 1. An acid solution is obtained by exfoliating and dissolving the plating layer 4 using 10 vol % of HCl containing an inhibitor that suppresses the corrosion of the first steel sheet 1. Next, the obtained acid solution is subjected to ICP analysis. As a result, the chemical composition of the plating layer 4 is obtained.

In a case where the welded joint 10 is provided with a coating on its surface, the above-described measurement is performed after the coating is removed with DESCOAT 110B manufactured by NEOS COMPANY LIMITED.

Next, a surface (surface A in FIG. 1) of the welded joint 10 according to the present embodiment, that has the weld bead portion 3, will be described with reference to FIGS. 1 to 3.

In the welded joint 10 according to the present embodiment, when observing a cross section orthogonal to an extending direction of the weld bead portion 3, in a surface having the weld bead portion 3, toward a direction orthogonal to the extending direction of the weld bead portion 3 and away from a toe of the weld bead portion 3, in a region from a position set as a starting point where the coating with the plating layer 4 is started to a position 1,000 μm away from the starting point, and in a surface layer region that is a region from the surface of the first steel sheet 1 to a position 50 μm away from the surface, Expression (1) is satisfied, where La is a length of a grain boundary at which an Fe—Al phase is present in grain boundaries and Lz is a length of a grain boundary at which an Fe—Zn phase is present in the grain boundaries, and an area ratio of an Mg—Zn phase in the plating layer 4 of the region from the starting point to the position 1,000 μm away from the starting point is 5% or more.

$$La / ( La + Lz ) \times 100 \geq 20 \qquad ( 1 )$$

In the present embodiment, the surface layer region is a region from the surface of the first steel sheet 1 to a position 50 μm away from the surface. In other words, the surface layer region is a region starting from the surface of the first steel sheet 1 and the second steel sheet 2 and ending at a position 50 μm away from the surface in a sheet thickness direction. The surface mentioned here is an interface between the plating layer 4 and the first steel sheet 1.

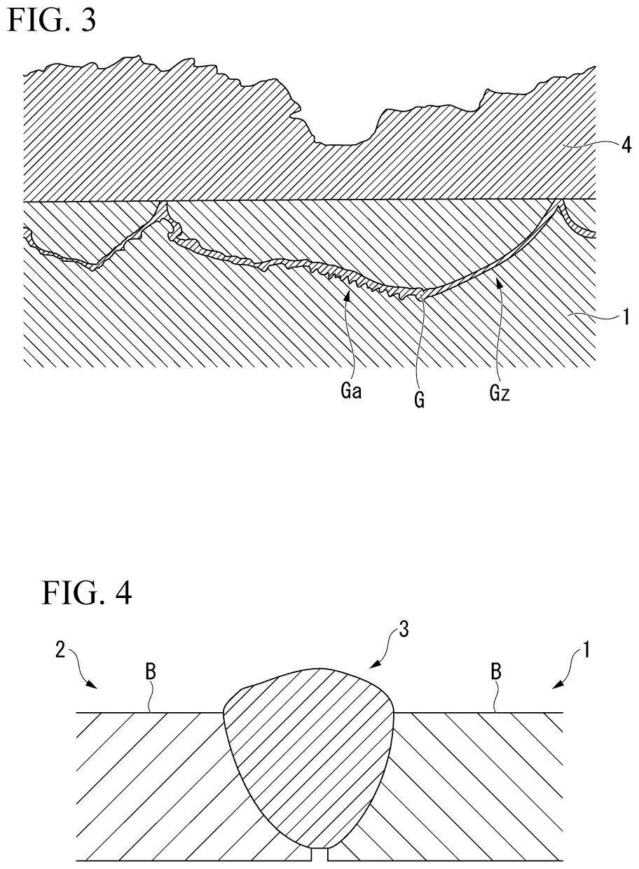

FIG. 1 is a diagram showing a cross section orthogonal to the extending direction of the weld bead portion 3 of the welded joint 10. The surface A (hereinafter, may be referred to as the bead surface A) having the weld bead portion 3 has the heat-affected zone a affected by heat due to welding and the non-heat-affected zone b not affected by heat. FIG. 2 is an enlarged view of the heat-affected zone a of the bead surface A on the first steel sheet 1 side in FIG. 1. As shown in FIG. 2, in the heat-affected zone a of the bead surface A, a part where the plating layer 4 is not present and the first steel sheet 1 is exposed, and a part coated with the plating layer 4 are present.

In the present embodiment, toward a direction orthogonal to the extending direction of the weld bead portion 3 and away from the toe of the weld bead portion 3, in a region from a position set as a starting point where the coating with the plating layer 4 is started to a position 1,000 μm away from the starting point, and in a surface layer region that is a region from the surface of the first steel sheet 1 to a position 50 μm away from the surface, Expression (1) is satisfied, where La is a length of the grain boundaries at which an Fe—Al phase is present in the grain boundaries and Lz is a length of the grain boundaries at which an Fe—Zn phase is present in the grain boundaries.

Note that the toe of the weld bead portion 3 is a boundary between the weld bead portion 3 and the first steel sheet 1, and is a point E shown in FIG. 1. In addition, the direction away from the toe (the point E in FIG. 1) of the weld bead portion 3 is a direction opposite to the weld bead portion 3 when viewed from the toe E, and is a direction D shown in FIG. 2. In addition, the position (starting point) where the coating with the plating layer 4 is started is a boundary between a part where the first steel sheet 1 is exposed and a part coated with the plating layer 4 on the surface of the first steel sheet 1 in the heat-affected zone a, and is a point S shown in FIGS. 1 and 2.

In the region from the starting point S to the position 1,000 μm away from the starting point S, the heat-affected zone a affected by heat due to welding is present. The size of the heat-affected zone a changes depending on the heat input amount during welding, the sheet thickness of the first steel sheet 1, and the like. However, in the region from the starting point S to the position 1,000 μm away from the starting point S, the heat-affected zone a is present in at least a part (particularly, the starting point S side) of the region. In the present embodiment, the LME resistance in the heat-affected zone a is improved by preferably controlling the surface layer region of the first steel sheet 1 in the heat-affected zone a.

The chemical composition of the plating layer 4 in the heat-affected zone a may include, for example, by mass %, Zn+Mg: 50% or more, Fe: 5% or less, and a remainder comprising Al and impurities.

A part of Zn in the plating layer 4 infiltrates into the grain boundaries of the surface layer region due to heat during welding. The Zn infiltrating into the grain boundaries combines with Fe in the first steel sheet 1 and forms an Fe—Zn phase. In addition, similar to Zn, Al in the plating layer 4 infiltrates into the grain boundaries and forms an Fe—Al phase. Since the Fe—Al phase has a higher melting point than the Fe—Zn phase, the Fe—Al phase does not melt by heat during welding. Therefore, the LME resistance can be increased by forming a desired amount of the Fe—Al phase at the grain boundaries.

FIG. 3 is an enlarged view of a part of the region from the starting point S to the position 1,000 μm away from the starting point S in FIG. 2. As shown in FIG. 3, at grain boundaries G of the surface layer region of the heat-affected zone a, a part Gz where an Fe—Zn phase is formed along the grain boundaries G and a part Ga where an Fe—Al phase is formed along the grain boundaries G are present. The Fe—Al phase has an uneven shape as shown in FIG. 3, and is called a tongue-shaped structure. In the present embodiment, the LME resistance can be increased by increasing the length of the part Ga where the Fe—Al phase is formed relative to the length of the part Gz where the Fe—Zn phase is formed.

In a case where the value on the left side of Expression (1) is less than 20, the length of the part Ga where the Fe—Al phase is formed is short for the length of the part Gz where the Fe—Zn phase is formed, and thus the LME resistance deteriorates. Therefore, the value on the left side of Expression (1) is set to 20 or more. In order to increase the LME resistance by making the length of the part Ga where the Fe—Al phase is formed longer for the length of the part Gz where the Fe—Zn phase is formed, the value on the left side of Expression (1) is preferably set to 50 or more, and more preferably 80 or more after increasing the Al content in the plating layer 4.

The larger the value on the left side of Expression (1), the better. Therefore, the value on the left side of Expression (1) may be set to 100.

The lengths of the part Gz where the Fe—Zn phase is formed and the part Ga where the Fe—Al phase is formed are measured by the following method.

A cross section of the first steel sheet along the sheet thickness direction is observed using a scanning electron microscope as shown in FIG. 3, and grain boundaries are observed in the surface layer region (the region from the surface to the position 50 μm away from the surface) of the first steel sheet 1. The grain boundaries are grain boundaries specified by a method described below.

In the region from the starting point S to the position 1,000 μm away from the starting point S, point analysis is performed on the grain boundaries using SEM-EPMA (manufactured by JEOL Ltd., JXA-8500F) to quantitatively analyze elements (Fe, Zn, and Al). A distribution image at the grain boundaries is measured with an acceleration voltage of 15 kV, a magnification of 5,000 times, and a measurement interval of 1.0 μm.

In the grain boundaries, a measurement point at which Fe: 5% to 90%, Zn: 20% to 95%, and Al: 0.5% or less is regarded as the part Gz where the Fe—Zn phase is formed, and a measurement point at which Fe: 5% to 90%, Zn: 10% to 80%, and Al: 5% to 70% is regarded as the part Ga where the Fe—Al phase is formed. By calculating the lengths of the parts, the length of the part Gz where the Fe—Zn phase is formed and the length of the part Ga where the Fe—Al phase is formed are obtained.

In a case where a plurality of the starting points S are present, the above-described measurement is performed on a region from the starting point S closest to the toe E of the weld bead portion 3 to a position 1,000 μm away from the starting point S.

Regarding a sample to be collected, a sample having a size of 20 mm×15 mm×sheet thickness is collected from the welded joint 10 so that the above cross section can be observed. The sample is embedded in a resin, mirror-polished to finish the cross section, and then subjected to the measurement.

In addition, a reflected electron image of the cross section is taken, and from a difference in brightness, a region positioned closest to the center in the sheet thickness is determined as the first steel sheet 1, and a layer excluding the region is determined as the plating layer 4. In a case where the welded joint 10 is provided with a coating on its surface, the layer present in the middle in the reflected electron image is subjected to SEM-EPMA analysis described later. In a case where the obtained chemical composition satisfies the chemical composition (by mass %, Zn+Mg: 50% or more, Fe: 5% or less, and a remainder comprising Al and impurities) of the plating layer 4 in the heat-affected zone a described above, the layer is determined as the plating layer 4 in the heat-affected zone a.

The grain boundaries are determined by obtaining a crystal orientation difference in the surface layer region by the following method.

From the welded joint 10, a sample is collected so that a region from the starting point S of the first steel sheet 1 to the position 1,000 μm away from the starting point S can be observed. A cross section of the sample is polished using #600 to #1500 silicon carbide paper and is then mirror-finished using a liquid obtained by dispersing a diamond powder having a grain size of 1 to 6 μm in a diluted solution of alcohol or the like or pure water. Next, electrolytic polishing is performed to finish the observation surface. Using this sample, crystal orientation information is obtained by an electron backscatter diffraction method with a measurement interval of 0.2 μm in the surface layer region of the first steel sheet 1. For the measurement, an EBSD analyzer including a thermal field emission scanning electron microscope and an EBSD detector, such as an EBSD analyzer including JSM-7001F manufactured by JEOL Ltd. and a DVC5 detector manufactured by TSL solutions is used. In this case, the degree of vacuum inside the EBSD analyzer is set to 9.6×10⁻⁵ Pa or less, the acceleration voltage is set to 15 kV, and the irradiation current level is set to 13.

Using the obtained crystal orientation information and a “grain average misorientation” function installed in software “OIM Analysis (registered trademark)” attached to the EBSD analyzer, a boundary with a crystal orientation difference of 5° or more is specified. The specified boundary is determined as a grain boundary.

### Area Ratio of Mg—Zn Phase: 5% or More

The Mg—Zn phase has an effect for increasing the red rust resistance. In a case where the area ratio of the Mg—Zn phase in the plating layer 4 in the region from the starting point S to the position 1,000 μm away from the starting point S is less than 5%, the red rust resistance in the heat-affected zone a deteriorates. Therefore, the area ratio of the Mg—Zn phase is set to 5% or more. In order to further improve the red rust resistance, the area ratio of the Mg—Zn phase is preferably set to 20% or more, and more preferably 30% or more after the increase of the Mg content in the plating layer 4.

The area ratio of the Mg—Zn phase may be set to 80% or less.

The area ratio of the Mg—Zn phase in the plating layer 4 is measured by the following method.

A sample having a size of 20 mm×15 mm×sheet thickness is collected from the welded joint 10 so that a cross section of the first steel sheet along the sheet thickness direction can be observed as shown in FIG. 3. The sample is embedded in a resin, and then mirror-polished to finish the cross section. Next, point analysis is performed on the cross section using SEM-EPMA to quantitatively analyze elements (Mg, Zn, and Fe). A phase with an Mg content of 20% to 60%, a Zn content of 40% to 80%, and a remainder of 5% or less is determined as the Mg—Zn phase. The above-described analysis is performed on the plating layer 4 in the region from the starting point S to the position 1,000 μm away from the starting point S, thereby obtaining the area ratio of the Mg—Zn phase.

A distribution image of a range of plating layer thickness×1,000 μm is measured with an acceleration voltage of 15 kV, a magnification of 5,000 times, and a measurement interval of 1.0 μm. The area ratio is calculated using the “Analyze” function of image analysis software “ImageJ”.

### Mg₂Sn Phase

In the welded joint 10 according to the present embodiment, the plating layer 4 of the non-heat-affected zone b preferably has an Mg₂Sn phase. In a case where the plating layer 4 of the non-heat-affected zone b has an Mg₂Sn phase, the red rust resistance in the non-heat-affected zone can be increased.

Whether or not the plating layer 4 of the non-heat-affected zone b has an Mg₂Sn phase is determined by the following method.

Since the amount of the Mg₂Sn phase is small, the presence of the Mg₂Sn phase is detected and confirmed by X-ray diffraction measurement using a 0-20 method. The X-ray diffraction measurement in the detection of the Mg₂Sn phase is performed by a θ-2θ measurement method. In addition, in the X-ray diffraction measurement, in a case where a peak is detected at 23.4±0.3° using Kα rays of a Cu bulb for the plating layer 4 in a 20 mm square sample collected from the non-heat-affected zone b (the position 100 mm or more away from the weld bead portion 3), it is determined that the Mg₂Sn phase is present.

The amount of the plating layer 4 attached per surface may be, for example, within a range of 20 to 250 g/m². By setting the amount of the plating layer 4 attached per surface to 20 g/m² or more, the red rust resistance can be further increased. On the other hand, by setting the amount of the plating layer 4 attached per surface to 250 g/m² or less, the workability can be further increased.

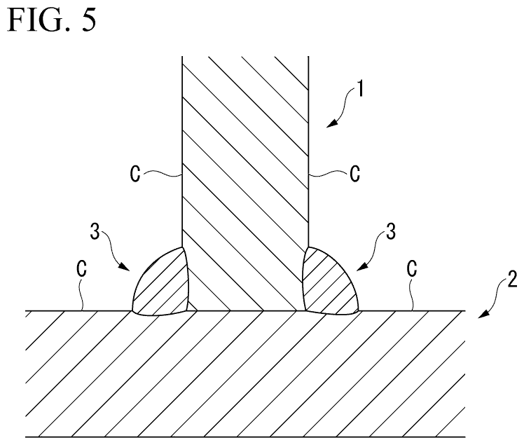

In addition, the above-described welded joint 10 is a lap joint, but the welded joint 10 according to the present embodiment is not limited thereto. The welded joint 10 according to the present embodiment may be, for example, a butt joint having a cross section as shown in FIG. 4, a T-joint having a cross section as shown in FIG. 5, or any other joint. In a case where the welded joint 10 is a butt joint, a surface B shown in FIG. 4 is regarded as a bead surface. In a case where the welded joint 10 is a T-joint, a surface C shown in FIG. 5 is regarded as a bead surface.

In the butt joint shown in FIG. 4, the weld bead portion 3 does not reach a back bead surface (the surface opposite to the bead surface B in FIG. 4), but the weld bead portion 3 may have a shape that it reaches the back bead surface. In addition, the weld bead portion 3 may be formed on both surfaces. In a case where the weld bead portion 3 reaches the back bead surface, the surface where the weld bead portion 3 is larger is regarded as the bead surface B. In a case where the weld bead portion 3 is formed on both surfaces, the surface where the weld bead portion 3 is larger is regarded as the bead surface B, and in a case where the weld bead portions 3 on both surfaces have the same size, any one of the surfaces is regarded as the bead surface B.

The first steel sheet has been described for convenience of description, but the same applies even in a case where the first steel sheet and the second steel sheet are interchanged.

Next, a preferable method of producing the welded joint 10 according to the present embodiment will be described.

A preferable method of producing the welded joint 10 according to the present embodiment includes:
a step of performing shot blasting on the first steel sheet 1;
a step of performing annealing;
a step of applying a plating;
a step of cooling; and
a step of welding the first steel sheet 1 and the second steel sheet 2.

The producing method for the second steel sheet is not particularly limited, but the second steel sheet may be produced by the same method as that for the first steel sheet.

Hereinafter, each step will be described.

### Shot Blasting

By performing shot blasting on the first steel sheet 1, strain is applied before application of a plating. In a case where shot blasting is performed under preferable conditions, strain is preferably applied to the first steel sheet 1, and thus it is possible to promote alloying in the plating layer 4 in combination with the below-described cooling after application of a plating. In addition, it is possible to promote the infiltration of Al into the grain boundaries along with Zn. As a result, it is possible to preferably control the morphologies of the surface layer region of the first steel sheet 1 and the plating layer 4.

In the shot blasting, steel balls having a central grain size of 40 to 450 μm can be used. Examples of the device include TSH30 manufactured by WINOA IKK JAPAN CO., LTD. The projection amount of the shot blasting is preferably set to 10 to 500 kg/m². In a case where the projection amount of the shot blasting is less than 10 kg/m², strain cannot be preferably applied to the first steel sheet 1, and as a result, the surface layer region of the first steel sheet 1 cannot be preferably controlled in some cases.

Strain can also be applied by surface grinding. However, since the amount of strain applied by surface grinding is smaller than that applied by shot blasting, a desired amount of strain cannot be applied.

### Annealing

After the shot blasting is performed, the first steel sheet 1 is annealed. The annealing temperature during annealing is set within a temperature range of 400° C. to 600° C., and the holding time (annealing time) in the temperature range is set to be longer than 0 second and 100 seconds or shorter. In a case where the annealing temperature is higher than 600° C. or the annealing time is longer than 100 seconds, strain in the first steel sheet 1 is released, and as a result, the surface layer region of the first steel sheet 1 cannot be preferably controlled in some cases. In a case where the annealing temperature is lower than 400° C. or the annealing is not performed, plating cannot be preferably applied in some cases.

The temperature mentioned here is the surface temperature at a center portion of the sheet surface of the first steel sheet 1, and can be measured using a thermocouple joined by spot welding or the like.

### Plating

After the annealing, the first steel sheet 1 is immersed in a plating bath. The composition of the plating bath is controlled so that the plating layer 4 has the chemical composition of the plating layer 4 described above. The bath temperature of the plating bath is preferably set to 600° C. or lower. In a case where the bath temperature of the plating bath is higher than 600° C., strain in the first steel sheet 1 is released, and as a result, the surface layer region of the first steel sheet 1 cannot be preferably controlled in some cases.

After the first steel sheet 1 is lifted from the plating bath, the plating adhesion amount may be adjusted by gas wiping or the like.

### Cooling

After the plating is applied, cooling is preferably performed using a cooling gas having a dew point of −20° C. or lower so that the average cooling rate in a temperature range of the bath temperature to 250° C. is 15° C./s or faster. Then, cooling is preferably performed using a cooling gas having a dew point of 0° C. or higher so that the average cooling rate in a temperature range of 250° C. to 50° C. is 5° C./s or slower.

In the cooling in the temperature range of the bath temperature to 250° C., in a case where the dew point of the cooling gas is higher than-20° C., Zn may evaporate, and the plating layer 4 cannot be preferably controlled in some cases. In the cooling in the temperature range of the bath temperature to 250° C., in a case where the average cooling rate is slower than 15° C./s, Zn may evaporate, and the plating layer 4 cannot be preferably controlled in some cases.

In the cooling in the temperature range of 250° C. to 50° C., in a case where the dew point of the cooling gas is lower than 0° C., the oxide of Al or Mg cannot be sufficiently formed in the plating layer 4, and as a result, Zn in the plating layer 4 may evaporate too much, and the plating layer 4 cannot be preferably controlled in some cases. In addition, in a case where the average cooling rate in the temperature range of 250° C. to 50° C. is faster than 5° C./s, Zn may evaporate, and the plating layer 4 cannot be preferably controlled in some cases.

### Welding

After the cooling, the first steel sheet 1 and the second steel sheet 2 are welded, and thus the welded joint 10 is obtained. The welding method is not particularly limited as long as the weld bead portion 3 is formed. For example, in a case where arc welding and laser welding are performed, the following conditions can be set for each welding.

### Arc Welding

Welding Current: 250 A
Welding Voltage: 26.4 V
Welding Speed: 100 cm/min
Welding Gas: 20% CO2+Ar
Gas Flow Rate: 20 L/min
Welding Wire: YGW16 manufactured by NIPPON STEEL WELDING & ENGINEERING CO., LTD. (+1.2 mm (C: 0.1 mass %, Si: 0.80 mass %, Mn: 1.5 mass %, P: 0.015 mass %, S: 0.008 mass %, Cu: 0.36 mass %)
Inclination Angle of Welding Torch: 45°

### Laser Welding

Output: 7 kW
Welding Speed: 400 cm/min
Advance/Retreat angle: 0°

The welded joint 10 according to the present embodiment can be stably produced using the above-described method. Since the welded joint 10 according to the present embodiment has excellent coating adhesion, coating may be performed on the surface for the purpose of improving the corrosion resistance or the like of the welded joint 10.

### EXAMPLES

First steel sheets and second steel sheets having the mechanical properties of SS400 of JIS G 3101:2020 were subjected to shot blasting, annealing, plating, and cooling under the conditions shown in Tables 2A and 2B, and then welded by the welding methods shown in Tables 3A and 3B to obtain lap joints (welded joints).

The first steel sheets and the second steels sheet had a size of 200 mm×100 mm×3.2 mm. The lifting speed from a plating bath was set to 20 to 200 mm/sec. In the lifting, the plating adhesion amount was adjusted by gas wiping using N₂ gas.

For conditions not shown in the tables, the same conditions as those described above were employed.

In a case where arc welding was employed as a welding method, regarding steel sheet sizes, 150×50 mm was set for the upper sheet side (first steel sheet) and 150×30 mm was set for the lower sheet side (second steel sheet). In addition, the overlapping margin was set to 10 mm, and the sheet gap was set to 0 mm.

In a case where laser welding was employed as a welding method, regarding steel sheet sizes, 150×50 mm was set for the upper sheet side (first steel sheet) and 150×30 mm was set for the lower sheet side (second steel sheet). In addition, the overlapping margin was set to 50 mm, and the sheet gap was set to 0 mm.

The obtained welded joints were subjected to measurement of the chemical composition of a plating layer of a non-heat-affected zone, evaluation of the grain boundaries of a surface layer region in a region from a starting point to a position 1,000 μm away from the starting point, and measurement of the area ratio of an Mg—Zn phase in the region in accordance the above-described methods, and further subjected to determination of the presence or absence of an Mg₂Sn phase. The measurement results of the chemical compositions of the plating layers are shown in Tables 1A and 1B, and other measurement results are shown in Tables 3A and 3B.

Next, the welded joints were subjected to a phosphoric acid chemical conversion treatment P-01 for building materials (Nippon Paint Industrial Coatings Co., Ltd. standard) and baking at a maximum achieving temperature of 210° C. for 40 seconds using a polyester-based coating material NSC300HQ (Nippon Paint Industrial Coatings Co., Ltd. standard), and thus coatings were applied thereon so that their coating thicknesses after drying were 15 μm.

### Evaluation of LME Resistance

A region from a starting point to a position 1,000 μm away from the starting point in a bead surface of the welded joint was subjected to a penetrant test (color check) according to JIS Z 2343-1:2017 to evaluate LME resistance according to the number of cracks generated by LME cracking. The evaluation criteria are as follows.

The presence or absence of a crack was determined depending on the presence or absence of a stained site. In a case where it was difficult to determine whether the crack was caused by LME cracking, the cracked portion was cut to analyze a cross section using SEM-EPMA, and it was analyzed whether Zn was contained in the crack. In a case where Zn was contained in the crack, the crack was determined to be generated by LME cracking. In a case where the evaluation result was at Level A or higher, the LME resistance in the heat-affected zone was determined to be excellent and successful. On the other hand, in a case where the evaluation result was at Level B, the LME resistance in the heat-affected zone was determined to be inferior and not successful.
AAA: No crack
AA: A crack occurred at 1 or more and less than 4 locations.
A: A crack occurred at 4 or more and less than 8 locations.
B: A crack occurred at 8 or more locations.

### Evaluation of Red Rust Resistance

A combined cycle corrosion test according to JASO (M609-91) was performed on the welded joints after coating. A region from a starting point to a position 1,000 μm away from the starting point in a bead surface of the welded joint was subjected to red rust resistance evaluation according to the timing of the occurrence of blisters. The region was observed with an optical microscope. In a case where the protrusion of the coating film was confirmed, it was determined that a blister had occurred. The evaluation criteria were as follows. In a case where the evaluation result was at Level A or higher, the red rust resistance in the heat-affected zone was determined to be excellent and successful. On the other hand, in a case where the evaluation result was at Level B, the red rust resistance in the heat-affected zone was determined to be inferior and not successful.
AAA: No red rust was generated in 240 cycles.
AA: A red rust was generated in 120 or more cycles and less than 240 cycles.
A: A red rust was generated in 60 or more cycles and less than 120 cycles.
B: A red rust was generated in less than 60 cycles.

In addition, the red rust resistance in the non-heat-affected zone of the welded joint was evaluated by the same method. As a region for evaluation, a region of 50 mm×50 mm was set at a position 100 mm or more away from a weld bead portion in a surface having a weld bead. The evaluation criteria were as follows, and in a case where the evaluation result was at Level AA or higher, the red rust resistance in the non-heat-affected zone was determined to be excellent.
AAA: No red rust was generated in 240 cycles.
AA: A red rust was generated in 120 or more and less than 240 cycles.
A: A red rust was generated in 60 or more and less than 120 cycles.
B: A red rust was generated in less than 60 cycles.

TABLE 1A

| | | Chemical Composition of Plating Layer of Non-Heat-Affected Zone (mass %) | | | | | | | | |
|---|---|---|---|---|---|---|---|---|---|---|
| No | Classification | Zn | Al | Mg | Fe | Si | Ca | Sn | Others | |
| 1 | Example | 91.880 | 5.0 | 3.0 | 0.10 | 0 | 0 | 0 | Co | 0.0200 |
| 2 | Example | 75.380 | 7.6 | 15.0 | 0.50 | 0 | 1.5000 | 0 | V | 0.0200 |
| 3 | Example | 85.080 | 10.1 | 4.0 | 0.80 | 0 | 0 | 0 | Ni | 0.0200 |
| 4 | Example | 85.280 | 10.0 | 4.5 | 0.10 | 0.10 | 0 | 0 | Ti | 0.0200 |
| 5 | Example | 81.770 | 12.0 | 5.0 | 1.20 | 0 | 0 | 0 | Zr | 0.0300 |
| 6 | Example | 81.600 | 12.0 | 5.2 | 1.20 | 0 | 0 | 0 | — | |
| 7 | Example | 75.710 | 16.0 | 6.0 | 1.90 | 0 | 0.1000 | 0.2400 | W | 0.0500 |
| 8 | Example | 77.540 | 16.0 | 5.6 | 0.20 | 0.20 | 0.2000 | 0.2400 | Sb | 0.0200 |
| 9 | Example | 72.630 | 19.0 | 6.6 | 1.40 | 0 | 0.1000 | 0.2400 | Pb | 0.0300 |
| 10 | Example | 72.460 | 19.0 | 6.7 | 1.50 | 0 | 0.1000 | 0.2400 | — | |
| 11 | Example | 70.740 | 20.0 | 7.0 | 1.90 | 0 | 0.1000 | 0.2400 | La | 0.0200 |
| 12 | Example | 70.840 | 20.3 | 7.0 | 1.50 | 0 | 0.1000 | 0.2400 | Ce | 0.0200 |
| 13 | Example | 74.360 | 20.3 | 4.0 | 1.30 | 0 | 0 | 0.0200 | W | 0.0200 |
| 14 | Example | 74.399 | 20.1 | 4.0 | 1.50 | 0 | 0 | 0 | B | 0.0010 |
| 15 | Example | 72.057 | 20.3 | 7.0 | 0.20 | 0.10 | 0.1000 | 0.2400 | In | 0.0030 |
| 16 | Example | 71.050 | 20.4 | 7.2 | 1.20 | 0 | 0.1000 | 0.0200 | Nb | 0.0300 |
| 17 | Example | 60.140 | 22.2 | 15.0 | 0.90 | 0 | 1.5000 | 0.2400 | Li | 0.0200 |
| 18 | Example | 67.160 | 23.4 | 7.7 | 1.20 | 0 | 0.2000 | 0.2400 | Sr | 0.1000 |
| 19 | Example | 63.930 | 24.5 | 10.0 | 0.80 | 0.20 | 0.3000 | 0.2400 | Bi | 0.0300 |
| 20 | Example | 57.750 | 29.4 | 11.0 | 1.20 | 0.10 | 0.3000 | 0.2400 | Ag | 0.0100 |

TABLE 1B

| | | Chemical Composition of Plating Layer of Non-Heat-Affected Zone (mass %) | | | | | | | | |
|---|---|---|---|---|---|---|---|---|---|---|
| No | Classification | Zn | Al | Mg | Fe | Si | Ca | Sn | Others | |
| 21 | Example | 55.130 | 30.5 | 11.0 | 2.40 | 0.30 | 0.4000 | 0.2400 | Cu | 0.0300 |
| 22 | Example | 49.830 | 34.1 | 12.0 | 3.10 | 0.20 | 0.5000 | 0.2400 | Y | 0.0300 |
| 23 | Example | 44.360 | 38.0 | 12.0 | 4.30 | 0.50 | 0.5000 | 0.2400 | Mo | 0.1000 |
| 24 | Example | 43.840 | 38.9 | 12.0 | 4.00 | 0.50 | 0.5000 | 0.2400 | Cr | 0.0200 |
| 25 | Example | 32.830 | 40.0 | 12.0 | 4.40 | 10.00 | 0.5000 | 0.2400 | Mn | 0.0300 |
| 26 | Comparative | 91.500 | 4.6 | 3.0 | 0.90 | 0 | 0 | 0 | — | |
| | Example | | | | | | | | | |
| 27 | Comparative | 52.400 | 40.4 | 4.0 | 1.50 | 1.60 | 0.1000 | 0 | — | |
| | Example | | | | | | | | | |
| 28 | Comparative | 84.000 | 12.0 | 2.8 | 0.20 | 0 | 1.0000 | 0 | — | |
| | Example | | | | | | | | | |
| 29 | Comparative | 66.100 | 12.0 | 20.4 | 0.30 | 0.20 | 1.0000 | 0 | — | |
| | Example | | | | | | | | | |
| 30 | Comparative | 84.200 | 12.0 | 3.0 | 0.60 | 0.20 | 0 | 0 | — | |
| | Example | | | | | | | | | |
| 31 | Comparative | 83.400 | 12.0 | 4.0 | 0.30 | 0.20 | 0.1000 | 0 | — | |
| | Example | | | | | | | | | |
| 32 | Comparative | 82.700 | 12.0 | 4.0 | 0.20 | 0.10 | 1.0000 | 0 | — | |
| | Example | | | | | | | | | |
| 33 | Comparative | 84.400 | 12.0 | 3.0 | 0.30 | 0.20 | 0.1000 | 0 | — | |
| | Example | | | | | | | | | |
| 34 | Comparative | 84.400 | 12.0 | 3.0 | 0.40 | 0.10 | 0.1000 | 0 | — | |
| | Example | | | | | | | | | |
| 35 | Comparative | 84.150 | 12.0 | 3.0 | 0.55 | 0.20 | 0.1000 | 0 | — | |
| | Example | | | | | | | | | |
| 36 | Comparative | 84.000 | 12.0 | 3.0 | 0.80 | 0.10 | 0.1000 | 0 | — | |
| | Example | | | | | | | | | |
| 37 | Example | 76.400 | 18.0 | 4.0 | 0.20 | 0.20 | 0.2000 | 1.0000 | — | |
| 38 | Example | 36.380 | 40.0 | 8.0 | 15.00 | 0 | 0.5000 | 0.1200 | — | |
| 39 | Comparative | 84.420 | 12.0 | 3.0 | 0.30 | 0.18 | 0.1000 | 0 | — | |
| | Example | | | | | | | | | |
| 40 | Comparative | 82.020 | 14.0 | 3.5 | 0.20 | 0.18 | 0.1000 | 0 | — | |
| | Example | | | | | | | | | |
| 41 | Comparative | 82.900 | 13.0 | 3.5 | 0.40 | 0.10 | 0.1000 | 0 | — | |
| | Example | | | | | | | | | |

The underline indicates that the value was outside the range of the present disclosure.

TABLE 2A

| | | | | | | Cooling | | | |
|---|---|---|---|---|---|---|---|---|---|
| | | | | | | Bath Temperature | | | |
| | | Projection | | | | to 250° C. | | 250° C. to 50° C. | |
| | | Amount | | | | Average | | Average | |
| | | of Shot | Annealing | Annealing | Bath | Cooling | Dew | Cooling | Dew |
| | | Blasting | Temperature | Time | Temperature | Rate | Point | Rate | Point |
| No | Classification | (kg/m²) | (° C.) | (s) | (° C.) | (° C./s) | (° C.) | (° C./s) | (° C.) |
| 1 | Example | 10 | 600 | 100 | 440 | 15 | −40 | 5 | 0 |
| 2 | Example | 50 | 550 | 50 | 460 | 15 | −40 | 5 | 10 |
| 3 | Example | 10 | 550 | 50 | 460 | 15 | −40 | 5 | 10 |
| 4 | Example | 10 | 550 | 10 | 460 | 15 | −40 | 5 | 0 |
| 5 | Example | 10 | 550 | 20 | 430 | 15 | −40 | 5 | 0 |
| 6 | Example | 50 | 550 | 50 | 430 | 15 | −40 | 5 | 0 |
| 7 | Example | 10 | 550 | 20 | 470 | 15 | −40 | 5 | 0 |
| 8 | Example | 10 | 550 | 20 | 470 | 15 | −40 | 5 | 0 |
| 9 | Example | 10 | 550 | 20 | 480 | 15 | −40 | 5 | 0 |
| 10 | Example | 50 | 550 | 20 | 480 | 15 | −40 | 5 | 0 |
| 11 | Example | 50 | 550 | 5 | 480 | 15 | −40 | 5 | 0 |
| 12 | Example | 50 | 550 | 5 | 480 | 15 | −40 | 5 | 0 |
| 13 | Example | 50 | 550 | 5 | 480 | 15 | −40 | 5 | 0 |
| 14 | Example | 50 | 550 | 5 | 480 | 15 | −40 | 5 | 0 |
| 15 | Example | 50 | 550 | 5 | 480 | 15 | −40 | 5 | 0 |
| 16 | Example | 50 | 550 | 5 | 480 | 15 | −40 | 5 | 0 |
| 17 | Example | 50 | 550 | 5 | 600 | 15 | −40 | 5 | 0 |
| 18 | Example | 50 | 550 | 5 | 580 | 15 | −40 | 5 | 0 |
| 19 | Example | 50 | 550 | 5 | 580 | 15 | −40 | 5 | 0 |
| 20 | Example | 50 | 550 | 5 | 600 | 15 | −40 | 5 | 0 |

TABLE 2B

| | | | | | | Cooling | | | |
|---|---|---|---|---|---|---|---|---|---|
| | | | | | | Bath Temperature | | | |
| | | Projection | | | | to 250° C. | | 250° C. to 50° C. | |
| | | Amount | | | | Average | | Average | |
| | | of Shot | Annealing | Annealing | Bath | Cooling | Dew | Cooling | Dew |
| | | Blasting | Temperature | Time | Temperature | Rate | Point | Rate | Point |
| No | Classification | (kg/m²) | (° C.) | (s) | (° C.) | (° C./s) | (° C.) | (C/s) | (° C.) |
| 21 | Example | 50 | 550 | 5 | 600 | 15 | −40 | 5 | 0 |
| 22 | Example | 50 | 550 | 5 | 600 | 15 | −40 | 5 | 0 |
| 23 | Example | 50 | 550 | 5 | 600 | 15 | −40 | 5 | 0 |
| 24 | Example | 50 | 550 | 5 | 600 | 15 | −40 | 5 | 0 |
| 25 | Example | 50 | 550 | 5 | 600 | 15 | −40 | 5 | 0 |
| 26 | Comparative | 10 | 600 | 100 | 570 | 15 | −40 | 5 | 0 |
| | Example | | | | | | | | |
| 27 | Comparative | 10 | 600 | 100 | 620 | 15 | −40 | 5 | 0 |
| | Example | | | | | | | | |
| 28 | Comparative | 10 | 600 | 100 | 570 | 15 | −40 | 5 | 0 |
| | Example | | | | | | | | |
| 29 | Comparative | 10 | 600 | 100 | 570 | 15 | −40 | 5 | 0 |
| | Example | | | | | | | | |
| 30 | Comparative | 10 | 600 | 100 | 570 | 10 | −40 | 5 | 0 |
| | Example | | | | | | | | |
| 31 | Comparative | 10 | 600 | 100 | 570 | 15 | −10 | 5 | 0 |
| | Example | | | | | | | | |
| 32 | Comparative | 10 | 600 | 100 | 570 | 15 | −40 | 10 | 0 |
| | Example | | | | | | | | |
| 33 | Comparative | 10 | 600 | 100 | 570 | 15 | −40 | 5 | −40 |
| | Example | | | | | | | | |
| 34 | Comparative | 6 | 600 | 100 | 570 | 15 | −40 | 5 | 0 |
| | Example | | | | | | | | |
| 35 | Comparative | 10 | 650 | 100 | 570 | 15 | −40 | 5 | 0 |
| | Example | | | | | | | | |
| 36 | Comparative | 10 | 600 | 110 | 570 | 15 | −40 | 5 | 0 |
| | Example | | | | | | | | |
| 37 | Example | 15 | 550 | 20 | 470 | 15 | −40 | 5 | 0 |
| 38 | Example | 50 | 550 | 5 | 600 | 15 | −40 | 5 | 0 |
| 39 | Comparative | 0 | 600 | 100 | 570 | 15 | −40 | 5 | 0 |
| | Example | | | | | | | | |
| 40 | Comparative | Surface | 600 | 100 | 570 | 15 | −40 | 5 | 0 |
| | Example | Grinding | | | | | | | |
| 41 | Comparative | 9 | 600 | 100 | 570 | 15 | −40 | 5 | 0 |
| | Example | | | | | | | | |

The underline indicates that the value was outside the range of the present disclosure, or the production condition was not preferable.

TABLE 3A

| | | Cross Section Structure | | Plating Layer | | | | |
|---|---|---|---|---|---|---|---|---|
| | | of Bead Surface | | of Non-Heat- | | Evaluation | | |
| | | Left Side of | | Affected Zone | | LME | Red Rust | Red Rust |
| | | Expression | Mg—Zn | Presence or | | Resistance | Resistance | Resistance |
| | | (1) | Phase | Absence of | Welding | of Bead | of Bead | of Non-Heat- |
| No | Classification | (—) | (area %) | Mg₂Sn Phase | Method | Surface | Surface | Affected Zone |
| 1 | Example | 20 | 5 | Absent | Arc | A | A | A |
| 2 | Example | 52 | 80 | Absent | Arc | AA | AAA | AAA |
| 3 | Example | 50 | 16 | Absent | Arc | AA | A | A |
| 4 | Example | 81 | 24 | Absent | Arc | AAA | AA | AA |
| 5 | Example | 55 | 24 | Absent | Arc | AA | AA | AA |
| 6 | Example | 81 | 28 | Absent | Arc | AAA | AA | AA |
| 7 | Example | 80 | 30 | Present | Arc | AAA | AAA | AAA |
| 8 | Example | 88 | 33 | Present | Arc | AAA | AAA | AAA |
| 9 | Example | 89 | 34 | Present | Arc | AAA | AAA | AAA |
| 10 | Example | 100 | 35 | Present | Arc | AAA | AAA | AAA |
| 11 | Example | 100 | 38 | Present | Arc | AAA | AAA | AAA |
| 12 | Example | 100 | 44 | Present | Arc | AAA | AAA | AAA |
| 13 | Example | 100 | 33 | Present | Arc | AAA | AAA | AAA |
| 14 | Example | 98 | 38 | Absent | Arc | AAA | AAA | AA |
| 15 | Example | 100 | 34 | Present | Arc | AAA | AAA | AAA |
| 16 | Example | 97 | 39 | Present | Laser | AAA | AAA | AAA |
| 17 | Example | 99 | 60 | Present | Arc | AAA | AAA | AAA |
| 18 | Example | 95 | 30 | Present | Laser | AAA | AAA | AAA |
| 19 | Example | 98 | 44 | Present | Arc | AAA | AAA | AAA |
| 20 | Example | 96 | 45 | Present | Arc | AAA | AAA | AAA |

TABLE 3B

| | | Cross Section Structure | | Plating Layer | | | | |
|---|---|---|---|---|---|---|---|---|
| | | of Bead Surface | | of Non-Heat- | | Evaluation | | |
| | | Left Side of | | Affected Zone | | LME | Red Rust | Red Rust |
| | | Expression | Mg—Zn | Presence or | | Resistance | Resistance | Resistance |
| | | (1) | Phase | Absence of | Welding | of Bead | of Bead | of Non-Heat- |
| No | Classification | (—) | (area %) | Mg₂Sn Phase | Method | Surface | Surface | Affected Zone |
| 21 | Example | 93 | 43 | Present | Arc | AAA | AAA | AAA |
| 22 | Example | 100 | 40 | Present | Arc | AAA | AAA | AAA |
| 23 | Example | 100 | 40 | Present | Arc | AAA | AAA | AAA |
| 24 | Example | 93 | 38 | Present | Arc | AAA | AAA | AAA |
| 25 | Example | 100 | 37 | Present | Arc | AAA | AAA | AAA |
| 26 | Comparative | 0 | 5 | Absent | Arc | B | A | A |
| | Example | | | | | | | |
| 27 | Comparative | 0 | 5 | Absent | Arc | B | A | A |
| | Example | | | | | | | |
| 28 | Comparative | 20 | 4 | Absent | Arc | A | B | B |
| | Example | | | | | | | |
| 29 | Comparative | Plating was not possible | | | | | | |
| | Example | | | | | | | |
| 30 | Comparative | 0 | 0 | Absent | Arc | A | B | B |
| | Example | | | | | | | |
| 31 | Comparative | 0 | 0 | Absent | Arc | A | B | B |
| | Example | | | | | | | |
| 32 | Comparative | 0 | 0 | Absent | Arc | A | B | B |
| | Example | | | | | | | |
| 33 | Comparative | 0 | 0 | Absent | Arc | A | B | B |
| | Example | | | | | | | |
| 34 | Comparative | 0 | 0 | Absent | Arc | B | B | B |
| | Example | | | | | | | |
| 35 | Comparative | 0 | 5 | Absent | Arc | B | A | A |
| | Example | | | | | | | |
| 36 | Comparative | 0 | 6 | Absent | Arc | B | A | A |
| | Example | | | | | | | |
| 37 | Example | 89 | 32 | Present | Arc | AAA | AAA | AAA |
| 38 | Example | 98 | 34 | Present | Arc | AAA | AAA | AAA |
| 39 | Comparative | 0 | 0 | Absent | Arc | B | B | B |
| | Example | | | | | | | |
| 40 | Comparative | 0 | 6 | Absent | Arc | B | A | B |
| | Example | | | | | | | |
| 41 | Comparative | 19 | 0 | Absent | Arc | B | B | B |
| | Example | | | | | | | |

The underline indicates that the value was outside the range of the present disclosure, or the property was not preferable.

As shown in Tables 3A and 3B, it was found that welded joints having excellent LME resistance and red rust resistance in the heat-affected zone were obtained in the examples according to the present disclosure. On the other hand, it was found that one or more properties deteriorated in the comparative examples.

In Nos. 30 to 33, since Zn evaporated and LME did not occur, the LME resistance was evaluated as “A”. In No. 40 in which strain was applied by performing surface grinding instead of shot blasting, it was not possible to apply a desired amount of strain, and it was not possible to preferably control the surface layer region of the bead surface.

### INDUSTRIAL APPLICABILITY

According to the aspect of the present disclosure, it is possible to provide a welded joint having excellent LME resistance and red rust resistance in a heat-affected zone.

### EXPLANATION OF REFERENCES

1: first steel sheet
2: second steel sheet
3: weld bead portion
4: plating layer
10: welded joint
a: heat-affected zone
b: non-heat-affected zone
A, B, C: bead surface
S: starting point (position where coating with plating layer is started)
E: toe of weld bead portion
D: direction away from toe of weld bead portion

What is claimed is:

1. A welded joint in which a first steel sheet and a second steel sheet are welded, the welded joint comprising:
the first steel sheet and the second steel sheet; and
a weld bead portion formed by welding,
wherein each of the first steel sheet and the second steel sheet has a heat-affected zone positioned around the weld bead portion, and a non-heat-affected zone not affected by heat due to the welding,
the first steel sheet has a plating layer on a surface in the heat-affected zone and the non-heat-affected zone,
the plating layer of the non-heat-affected zone comprises, as a chemical composition, by mass %,
Al: 5.0% to 40.0%,
Mg: 3.0% to 15.0%,
Fe: 0.01% to 15.00%,
Si: 0% to 10.00%,
Ca: 0% to 1.5000%,
Sb: 0% to 0.5000%,
Pb: 0% to 0.5000%,
Sr: 0% to 0.5000%,
Cu: 0% to 1.0000%,
Ti: 0% to 1.0000%,
V: 0% to 1.0000%,
Cr: 0% to 1.0000%,
Nb: 0% to 1.0000%,
Ni: 0% to 1.0000%,
Mn: 0% to 1.0000%,
Mo: 0% to 1.0000%,
Sn: 0% to 1.0000%,
Zr: 0% to 1.0000%,
Co: 0% to 1.0000%,
W: 0% to 1.0000%,
Ag: 0% to 1.0000%,
Li: 0% to 1.0000%,
La: 0% to 0.5000%,
Ce: 0% to 0.5000%,
Y: 0% to 0.5000%,
Bi: 0% to 0.5000%,
In: 0% to 0.5000%,
B: 0% to 0.5000%, and
a remainder comprising Zn of 20.000% or more and impurities,
when observing a cross section orthogonal to an extending direction of the weld bead portion, in a surface having the weld bead portion,
toward a direction orthogonal to the extending direction of the weld bead portion and away from a toe of the weld bead portion, in a region from a position set as a starting point where coating with the plating layer is started to a position 1,000 μm away from the starting point, and in a surface layer region that is a region from the surface of the first steel sheet to a position 50 μm away from the surface,
Expression (1) is satisfied, where La is a length of a grain boundary at which an Fe—Al phase is present in grain boundaries and Lz is a length of a grain boundary at which an Fe—Zn phase is present in the grain boundaries, and
an area ratio of an Mg—Zn phase in the plating layer of the region from the starting point to the position 1,000 μm away from the starting point is 5% or more,
$$La / ( La + Lz ) \times 100 \geq 20. \qquad ( 1 )$$

2. The welded joint according to claim 1,
wherein the plating layer of the non-heat-affected zone comprises, as the chemical composition, by mass %, one or more of
Si: 0.01% to 10.00%,
Ca: 0.0001% to 1.5000%,
Sb: 0.0001% to 0.5000%,
Pb: 0.0001% to 0.5000%,
Sr: 0.0001% to 0.5000%,
Cu: 0.0001% to 1.0000%,
Ti: 0.0001% to 1.0000%,
V: 0.0001% to 1.0000%,
Cr: 0.0001% to 1.0000%,
Nb: 0.0001% to 1.0000%,
Ni: 0.0001% to 1.0000%,
Mn: 0.0001% to 1.0000%,
Mo: 0.0001% to 1.0000%,
Sn: 0.0001% to 1.0000%,
Zr: 0.0001% to 1.0000%,
Co: 0.0001% to 1.0000%,
W: 0.0001% to 1.0000%,
Ag: 0.0001% to 1.0000%,
Li: 0.0001% to 1.0000%,
La: 0.0001% to 0.5000%,
Ce: 0.0001% to 0.5000%,
Y: 0.0001% to 0.5000%,
Bi: 0.0001% to 0.5000%,
In: 0.0001% to 0.5000%, and
B: 0.0001% to 0.5000%.

3. The welded joint according to claim 1,
wherein the plating layer of the non-heat-affected zone comprises, as the chemical composition, by mass %,
Mg: 4.5% to 15.0%, and
the area ratio of the Mg—Zn phase in the plating layer of the region is 20% or more.

4. The welded joint according to claim 1,
wherein the plating layer of the non-heat-affected zone comprises, as the chemical composition, by mass %,
Mg: 5.5% to 15.0%, and
the area ratio of the Mg—Zn phase in the plating layer of the region is 30% or more.

5. The welded joint according to claim 1,
wherein the plating layer of the non-heat-affected zone comprises, as the chemical composition, by mass %,
Al: 10.0% to 40.0%, and
a value on a left side of Expression (1) is 50 or more.

6. The welded joint according to claim 3,
wherein the plating layer of the non-heat-affected zone comprises, as the chemical composition, by mass %,
Al: 10.0% to 40.0%, and
a value on a left side of Expression (1) is 50 or more.

7. The welded joint according to claim 4,
wherein the plating layer of the non-heat-affected zone comprises, as the chemical composition, by mass %,
Al: 10.0% to 40.0%, and
a value on a left side of Expression (1) is 50 or more.

8. The welded joint according to claim 1,
wherein the plating layer of the non-heat-affected zone comprises, as the chemical composition, by mass %,
Al: 15.0% to 40.0%, and
a value on a left side of Expression (1) is 80 or more.

9. The welded joint according to claim 3,
wherein the plating layer of the non-heat-affected zone comprises, as the chemical composition, by mass %,
Al: 15.0% to 40.0%, and
a value on a left side of Expression (1) is 80 or more.

10. The welded joint according to claim 4,
wherein the plating layer of the non-heat-affected zone comprises, as the chemical composition, by mass %,
Al: 15.0% to 40.0%, and
a value on a left side of Expression (1) is 80 or more.

11. The welded joint according to claim 1,
wherein the plating layer of the non-heat-affected zone comprises, as the chemical composition, by mass %,
Sn: 0.0200% to 1.0000%, and
the plating layer of the non-heat-affected zone has an Mg₂Sn phase.

12. The welded joint according to claim 3,
wherein the plating layer of the non-heat-affected zone comprises, as the chemical composition, by mass %,
Sn: 0.0200% to 1.0000%, and
the plating layer of the non-heat-affected zone has an Mg₂Sn phase.

13. The welded joint according to claim 4,
wherein the plating layer of the non-heat-affected zone comprises, as the chemical composition, by mass %,
Sn: 0.0200% to 1.0000%, and
the plating layer of the non-heat-affected zone has an Mg₂Sn phase.

14. The welded joint according to claim 5,
wherein the plating layer of the non-heat-affected zone comprises, as the chemical composition, by mass %,
Sn: 0.0200% to 1.0000%, and
the plating layer of the non-heat-affected zone has an Mg₂Sn phase.

15. The welded joint according to claim 6,
wherein the plating layer of the non-heat-affected zone comprises, as the chemical composition, by mass %,
Sn: 0.0200% to 1.0000%, and
the plating layer of the non-heat-affected zone has an Mg₂Sn phase.

16. The welded joint according to claim 7,
wherein the plating layer of the non-heat-affected zone comprises, as the chemical composition, by mass %,
Sn: 0.0200% to 1.0000%, and
the plating layer of the non-heat-affected zone has an Mg₂Sn phase.

17. The welded joint according to claim 8,
wherein the plating layer of the non-heat-affected zone comprises, as the chemical composition, by mass %,
Sn: 0.0200% to 1.0000%, and
the plating layer of the non-heat-affected zone has an Mg₂Sn phase.

18. The welded joint according to claim 9,
wherein the plating layer of the non-heat-affected zone comprises, as the chemical composition, by mass %,
Sn: 0.0200% to 1.0000%, and
the plating layer of the non-heat-affected zone has an Mg₂Sn phase.

19. The welded joint according to claim 10,
wherein the plating layer of the non-heat-affected zone comprises, as the chemical composition, by mass %,
Sn: 0.0200% to 1.0000%, and
the plating layer of the non-heat-affected zone has an Mg₂Sn phase.
